(19) United States
(12) Patent Application Publication
(10) Pub. No.: US 2021/0223496 A1
(43) Pub. Date: Jul. 22, 2021

(54) OPTICAL FILTERING APPARATUS, PHOTOGRAPHING APPARATUS, PHOTOGRAPHING SYSTEM AND MOVABLE OBJECT

(71) Applicant: SZ DJI TECHNOLOGY CO., LTD., Shenzhen (CN)

(72) Inventor: Futoshi IINUMA, Shenzhen (CN)

(73) Assignee: SZ DJI TECHNOLOGY CO., LTD., Shenzhen (CN)

(21) Appl. No.: 17/198,201

(22) Filed: Mar. 10, 2021

Related U.S. Application Data
(63) Continuation of application No. PCT/CN2020/075074, filed on Feb. 13, 2020.

(30) Foreign Application Priority Data
Feb. 25, 2019 (JP) 2019-032190

(51) Int. Cl. G02B 7/00; H04N 5/225; G03B 11/00; G03B 17/56

(52) U.S. Cl. CPC G02B 7/006; G03B 17/561; G03B 11/00; H04N 5/2254

(57) ABSTRACT

An apparatus includes a first and a second optical filter, a first and a second holding frame, at least two first and second supports, a first and a second motor, a first and a second transmission. A distance from an optical axis of a photographing apparatus to one of the at least two first supports supporting a first side member of the first holding frame is different from a distance from the optical axis to one of the at least two second supports supporting a first side member of the second holding frame. A distance from the optical axis to the other one of the at least two first supports supporting a second side member of the first holding frame is different from a distance from the optical axis to the other one of the at least two second supports supporting a second side member of the second holding frame.

### RELATED APPLICATIONS

This application is a continuation application of PCT application No. PCT/CN2020/075074, filed on Feb. 13, 2020, which claims priority of Japanese application No. JP2019-032190 filed on Feb. 25, 2019 and the content of which is incorporated herein by reference in its entirety.

### TECHNICAL FIELD

The present disclosure relates to an optical filtering apparatus, a photographing apparatus, a photographing system, and a movable object.

### BACKGROUND

Reference 1 discloses a light quantity adjustment apparatus capable of switching a plurality of light quantity adjustment components. It is desired to further reduce a thickness of an apparatus capable of switching a plurality of optical filters to make the apparatus smaller.

### PRIOR ART LITERATURE

Reference 1: International Publication No. 2014/119277

### BRIEF SUMMARY

### Technical Problem to be Resolved

It is desired to further reduce a thickness of an apparatus capable of switching a plurality of optical filters to make the apparatus smaller.

### Technical Solutions

According to some aspects of the present disclosure, an optical filtering apparatus is provided, including: a first optical filter; a first holding frame, holding the first optical filter; at least two first supports, slidably supporting a first side member and a second side member of the first holding frame, respectively; a first motor; a first transmission, transmitting power from the first motor to the first holding frame to drive the first holding frame to slide along the two first supports, causing the first optical filter to be inserted into or recede from an optical path of a photographic apparatus; a second optical filter; a second holding frame, holding the second optical filter; at least two second supports, being arranged adjacent to the at least two first supports respectively, and slidably supporting a first side member and a second side member of the second holding frame respectively; a second motor; and a second transmission, transmitting power from the second motor to the second holding frame to drive the second holding frame to slide along the two second supports, causing the second optical filter to be inserted into or recede from the optical path, where a distance from an optical axis of the photographing apparatus to one of the at least two first supports that supports the first side member of the first holding frame is different from a distance from the optical axis to one of the at least two second supports that supports the first side member of the second holding frame, and a distance from the optical axis to the other one of the at least two first supports that supports the second side member of the first holding frame is different from a distance from the optical axis to the other one of the at least two second supports that supports the second side member of the second holding frame.

According to some aspects of the present disclosure, a photographing system is provided, including: a photographing apparatus including an image sensor receiving light passing through an optical filtering apparatus; the optical filtering apparatus including: a first optical filter; a first holding frame, holding the first optical filter; at least two first supports, slidably supporting a first side member and a second side member of the first holding frame, respectively; a first motor; a first transmission, transmitting power from the first motor to the first holding frame to drive the first holding frame to slide along the two first supports, causing the first optical filter to be inserted into or recede from an optical path of a photographic apparatus; a second optical filter; a second holding frame, holding the second optical filter; at least two second supports, being arranged adjacent to the at least two first supports respectively, and slidably supporting a first side member and a second side member of the second holding frame respectively; a second motor; and a second transmission, transmitting power from the second motor to the second holding frame to drive the second holding frame to slide along the two second supports, causing the second optical filter to be inserted into or recede from the optical path, where a distance from an optical axis of the photographing apparatus to one of the at least two first supports that supports the first side member of the first holding frame is different from a distance from the optical axis to one of the at least two second supports that supports the first side member of the second holding frame, and a distance from the optical axis to the other one of the at least two first supports that supports the second side member of the first holding frame is different from a distance from the optical axis to the other one of the at least two second supports that supports the second side member of the second holding frame.

In addition, the above summary does not enumerate all the essential features of the present disclosure. In addition, sub-combinations of these feature groups may also constitute inventions.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some exemplary embodiments of the present disclosure, and a person of ordinary skill in the art may still derive other drawings from these accompanying drawings without creative efforts.

FIG. 1 is a front perspective view of the external appearance of a photographing apparatus as viewed from an image-taking-surface side according to some exemplary embodiments of the present disclosure;

FIG. 2 is a back perspective view of external appearance of the photographing apparatus as viewed from an opposite side of the camera surface according to some exemplary embodiments of the present disclosure;

FIG. 3 is a front view of the photographing apparatus without a housing according to some exemplary embodiments of the present disclosure;

FIG. 4 is an exemplary block diagram illustrating the functions of the photographing apparatus according to some exemplary embodiments of the present disclosure;

FIG. 5 is a front perspective view of the external appearance of an optical filtering apparatus according to some exemplary embodiments of the present disclosure;

FIG. 6 is a back perspective view of the external appearance of the optical filtering apparatus according to some exemplary embodiments of the present disclosure;

FIG. 7 is a front view of the optical filtering apparatus according to some exemplary embodiments of the present disclosure;

FIG. 8 is a cross-sectional view along A-A′ shown in FIG. 7 according to some exemplary embodiments of the present disclosure; and

FIG. 9 is a view of an exemplary external appearance of an unmanned aircraft and a remote operation device according to some exemplary embodiments of the present disclosure.

### REFERENCE NUMERALS

10 UAV
20 UAV main body
50 Gimbal
60 Photographing device
100 Photographing apparatus
110 Camera control member
120 Image sensor
130 Memory
300 Remote operation device
500 Optical filtering apparatus
501, 511, 521, 531 Neutral density filter
502, 512, 522, 532 Holding frame
5021, 5121, 5221, 5321 First side member
5022, 5122, 5222, 5322 Second side member
503, 513 Support
504, 514, 524, 534 Rack
505, 515, 525, 535 Worm gear
506, 516, 526, 536 Worm
507, 517, 527, 537 Transmission
508, 518, 528, 538 Motor
800 Lens Mount
801 Locking pin
802 Electrical contact

### DETAILED DESCRIPTION

The following describes some exemplary using implementations of the present disclosure. However, the following implementations do not limit the exemplary embodiments related to the claims. In addition, all combinations of features described in the implementations may not be necessary for the solutions of the disclosure.

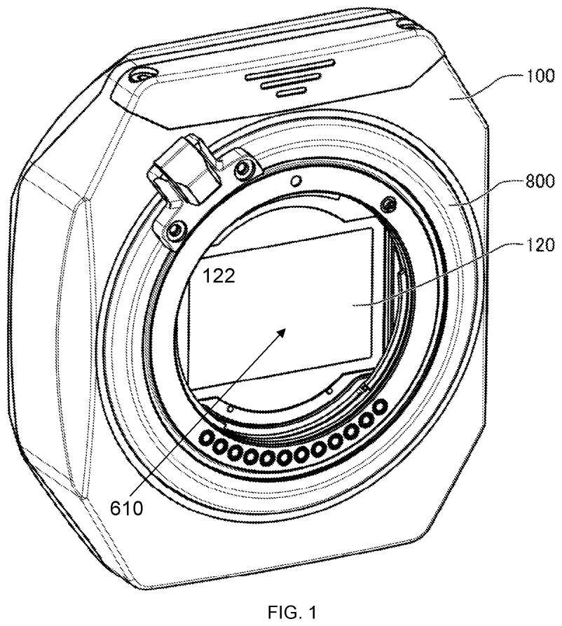

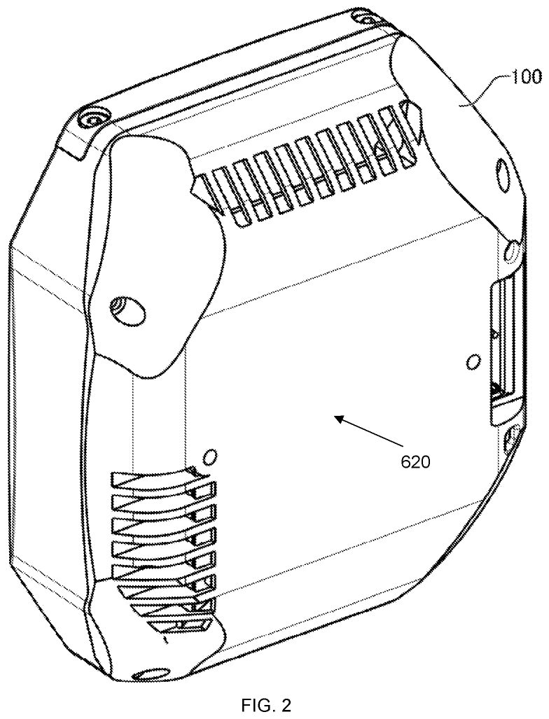

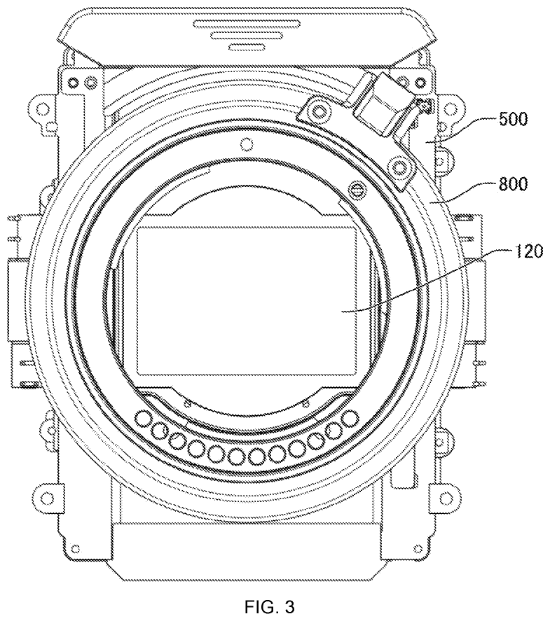

FIG. 1 is a perspective view of external appearance of a photographing apparatus 100 according to some exemplary embodiments of the present disclosure as viewed from an image-taking-surface side 610. FIG. 2 is a perspective view of external appearance of the photographing apparatus 100 as viewed from an opposite side 620 of the image-taking-surface side 610 according to some exemplary embodiments of the present disclosure. FIG. 3 is a front view of the photographing apparatus 100 without a housing according to some exemplary embodiments of the present disclosure.

The photographing apparatus 100 may include an image sensor 120 and a lens mount 800. The lens mount 800 may be detachably connected an interchangeable lens to the photographing apparatus 100. The photographing apparatus 100 may further include an optical filtering apparatus 500. The optical filtering apparatus 500 may be configured on an object side of the image sensor 120, and may adjust a quantity of light incident to the image sensor 120.

The photographing apparatus 100, with the interchangeable lens mounted thereon, may be supported by a support device used for adjusting an attitude of the photographing apparatus 100. The photographing apparatus 100 may be mounted on a movable object. The photographing apparatus 100 may be mounted on the movable object via the support device. A non-limiting exemplary movable object may include an object movable in the air, a vehicle movable on the ground, a ship movable on the water, or the like. A non-limiting exemplary object moving in the air may include an unmanned aerial vehicle (UAV), an aircraft, an airship, or a helicopter.

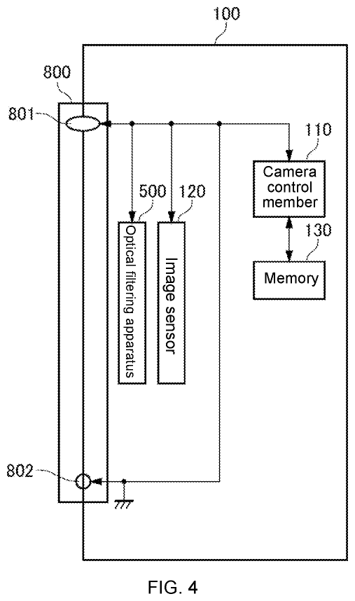

FIG. 4 is an exemplary block diagram illustrating the functions of the photographing apparatus 100 according to some exemplary embodiments of the present disclosure. The photographing apparatus 100 may include a camera control member 110, the image sensor 120, a memory 130, the optical filtering apparatus 500, and the lens mount 800. The image sensor 120 may include a CCD or a CMOS. The image sensor 120 may capture an optical image formed through the interchangeable lens, and may output the captured image to the camera control member 110. The image sensor 120 may receive light passing through the optical filtering apparatus 500. The camera control member 110 may include a microprocessor such as a CPU or an MPU, and a microcontroller such as an MCU. The camera control member 110 may control the photographing apparatus 100 according to an action instruction of the photographing apparatus 100.

The memory 130 may be a computer-readable recording medium, and may include at least one of flash memories such as an SRAM, a DRAM, an EPROM, an EEPROM, a USB memory, and a solid-state drive (SSD). The memory 130 may store a program necessary for the camera control member 110 to control the image sensor 120, and the like. The memory 130 may be disposed inside a housing of the photographing apparatus 100. The memory 130 may be configured to be detachable from the housing of the photographing apparatus 100.

The lens mount 800 may have a mechanical structure for detachably connecting the interchangeable lens to the photographing apparatus 100. The lens mount 800 may be configured at a position opposite to the image-taking-surface side of the image sensor 120. The lens mount 800 may have a locking pin 801 and an electrical contact 802. The locking pin 801 may be configured to apply a force to the object side by using an elastic object such as a spring. The interchangeable lens may rotate while pressing the locking pin 801 towards the image-taking-surface side 610. When the interchangeable lens rotates to a predetermined position, the locking pin 801 may be inserted into a positioning insertion hole of the interchangeable lens, to lock the interchangeable lens to the photographing apparatus 100. In addition, when the interchangeable lens rotates to the predetermined position, the electrical contact 802 may be electrically connected to an electrical contact of the interchangeable lens.

The photographing apparatus 100 as constructed in the foregoing manner may reduce a thickness of the optical filtering apparatus 500 in an optical axis direction, and may reduce a flange focal length indicating a distance between the lens mount 800 and the camera surface of the image sensor 120.

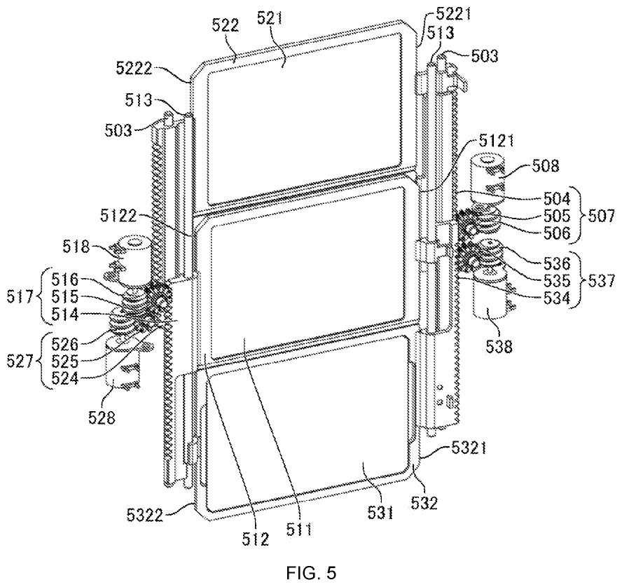

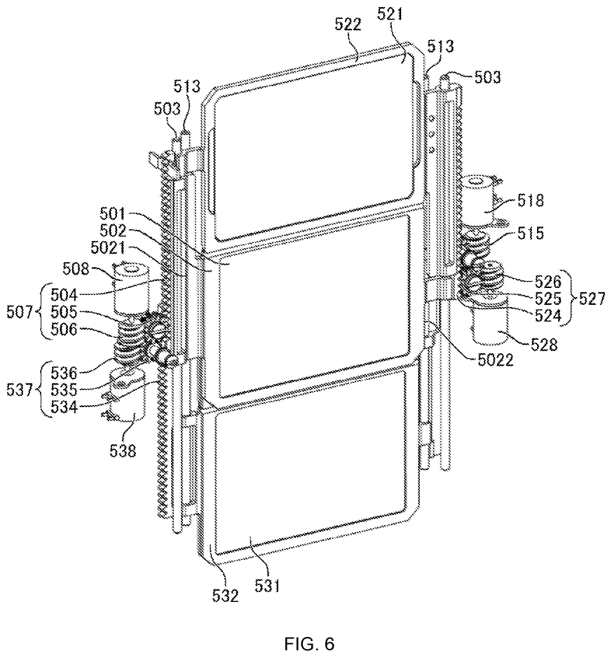

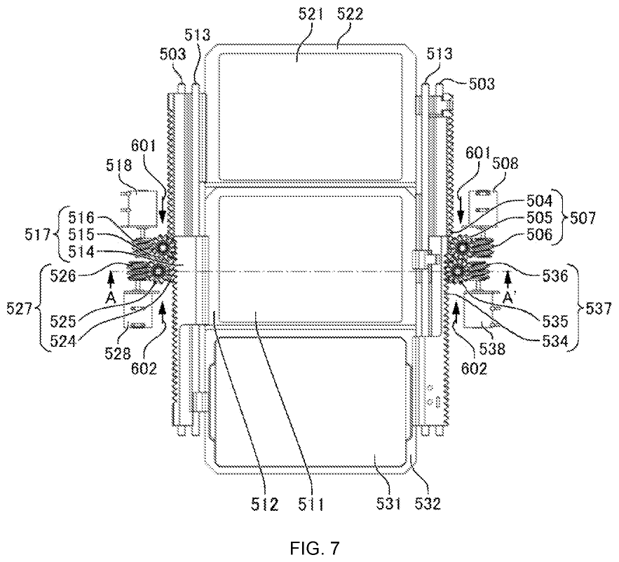

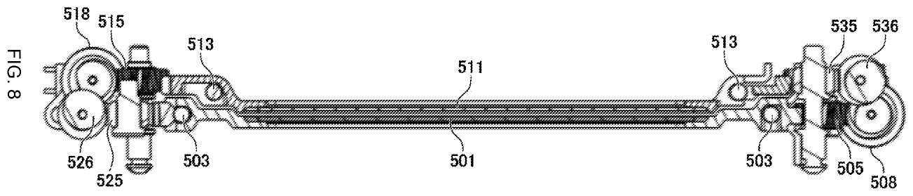

FIG. 5 is a front perspective view of the external appearance of the optical filtering apparatus 500 according to some exemplary embodiments of the present disclosure. FIG. 6 is a back perspective view of the external appearance of the optical filtering apparatus 500 according to some exemplary embodiments of the present disclosure. FIG. 7 is a front view of the optical filtering apparatus 500 according to some exemplary embodiments of the present disclosure. FIG. 8 is a cross-sectional view along A-A′ shown in FIG. 7 according to some exemplary embodiments of the present disclosure.

The optical filtering apparatus 500 may include a neutral density filter 501, a neutral density filter 511, a neutral density filter 521, and a neutral density filter 531. The optical filtering apparatus 500 may mechanically cause the neutral density filter 501, the neutral density filter 511, the neutral density filter 521, and the neutral density filter 531 to be inserted into or recede from an optical path of the photographing apparatus 100. The neutral density filter 501, the neutral density filter 511, the neutral density filter 521, and the neutral density filter 531 are non-limiting examples of a first optical filter, a second optical filter, a third optical filter, and a fourth optical filter, respectively. The optical filtering apparatus 500 may alternatively include at least four optical filters. In addition to the neutral density filter (ND optical filter), the optical filtering apparatus 500 may include an IR cut-off filter or a polarizing filter.

The optical filtering apparatus 500 may include a holding frame 502, at least two supports 503, a transmission 507, and a motor 508. The holding frame 502 may hold the neutral density filter 501. The at least two supports 503 may slidably support a first side member 5021 and a second side member 5022 of the holding frame 502 respectively. The at least two supports 503 may be rod sliding shafts. The at least two supports 503 may be configured in parallel along a plane perpendicular to an optical axis of the photographing apparatus 100.

The transmission 507 may transmit power from the motor 508 to the holding frame 502, to drive the holding frame 502 to slide along the at least two supports 503, causing the neutral density filter 501 to be inserted into or recede from the optical path of the photographing apparatus 100. The motor 508 may be a DC motor, a stepper motor, a coreless motor, or an ultrasonic motor. The holding frame 502 is a non-limiting example of a first holding frame. The support 503 is a non-limiting example of a first support. The transmission 507 is a non-limiting example of a first power transmission.

The transmission 507 may include: a rack 504 arranged on the first side member 5021 of the holding frame 502; a worm gear 505 engaged with the rack 504; and a worm 506 engaged with the worm gear 505 and connected to a drive shaft of the motor 508. If driven by the motor 508, the holding frame 502 slides along the at least two supports 503 via the worm 506, the worm gear 505, and the rack 504. In this way, the neutral density filter 501 may be inserted into or recedes from the optical path of the photographing apparatus 100. The worm 506, the worm gear 505, and the rack 504 are a non-limiting example of a first worm, a first worm gear, and a first rack, respectively.

The optical filtering apparatus 500 may further include a holding frame 512, at least two supports 513, a transmission 517, and a motor 518. The holding frame 512 may hold the neutral density filter 511. The at least two supports 513 may slidably support a first side member 5121 and a second side member 5122 of the holding frame 512 respectively. The at least two supports 513 may be rod sliding shafts. The at least two supports 513 may be configured in parallel along a plane perpendicular to the optical axis of the photographing apparatus 100. The plane in which the at least two supports 513 are configured and that is perpendicular to the optical axis of the photographing apparatus 100 may be different from the plane in which the at least two supports 503 are configured and that is perpendicular to the optical axis of the photographing apparatus 100. The at least two supports 503 and the at least two supports 513 may be staggered in the optical axis direction and adjacent to each other.

The transmission 517 may transmit power from the motor 518 to the holding frame 512, to drive the holding frame 512 to slide along the at least two supports 513, causing the neutral density filter 511 to be inserted into or recede from the optical path of the photographing apparatus 100. The motor 518 may be a DC motor, a stepper motor, a coreless motor, or an ultrasonic motor. The holding frame 512 is a non-limiting example of a second holding frame. The support 513 is a non-limiting example of a second support. The transmission 517 is a non-limiting example of a second transmission. The motor 508 and the motor 518 may be located on opposite sides with respect to the optical axis.

The transmission 517 may include: a rack 514 arranged on the second side member 5122 of the holding frame 512; a worm gear 515 engaged with the rack 514; and a worm 516 engaged with the worm gear 515 and connected to a drive shaft of the motor 518. If driven by the motor 518, the holding frame 512 may slide along the at least two supports 513 via the worm 516, the worm gear 515, and the rack 514. In this way, the neutral density filter 511 may be inserted into or recedes from the optical path of the photographing apparatus 100. The worm 516, the worm gear 515, and the rack 514 are non-limiting examples of a second worm, a second worm gear, and a second rack, respectively.

The optical filtering apparatus 500 may further include a holding frame 522, a transmission 527, and a motor 528. The holding frame 522 may hold the neutral density filter 521. The at least two supports 503 may slidably support a first side member 5221 and a second side member 5222 of the holding frame 522 respectively.

The transmission 527 may transmit power from the motor 528 to the holding frame 522, to drive the holding frame 522 to slide along the at least two supports 503, causing the neutral density filter 521 to be inserted into or recede from the optical path of the photographing apparatus 100. The motor 528 may be a DC motor, a stepper motor, a coreless motor, or an ultrasonic motor. The holding frame 522 is a non-limiting example of a third holding frame. The transmission 527 is a non-limiting example of a third transmission.

The transmission 527 may include: a rack 524 arranged on the second side member 5222 of the holding frame 522; a worm gear 525 engaged with the rack 524; and a worm 526 engaged with the worm gear 525 and connected to a drive shaft of the motor 528. If driven by the motor 528, the holding frame 522 may slide along the at least two supports 503 via the worm 526, the worm gear 525, and the rack 524. In this way, the neutral density filter 521 may be inserted into or recedes from the optical path of the photographing apparatus 100. The worm 526, the worm gear 525, and the rack 524 are non-limiting examples of a third worm, a third worm gear, and a third rack, respectively.

The optical filtering apparatus 500 may further include a holding frame 532, a transmission 537, and a motor 538. The holding frame 532 holds the neutral density filter 531. The at least two supports 513 may slidably support a first side member 5321 and a second side member 5322 of the holding frame 532 respectively.

The transmission 537 may transmit power from the motor 538 to the holding frame 532, to drive the holding frame 532 to slide along the at least two supports 513, causing the neutral density filter 531 to be inserted into or recede from the optical path of the photographing apparatus 100. The motor 538 may be a DC motor, a stepper motor, a coreless motor, or an ultrasonic motor. The holding frame 532 is a-non-limiting example of a fourth holding frame. The transmission 537 is an example of a fourth transmission.

The transmission 537 may include: a rack 534 arranged on the first side member 5321 of the holding frame 532; a worm gear 535 engaged with the rack 534; and a worm 536 engaged with the worm gear 535 and connected to a drive shaft of the motor 538. If driven by the motor 538, the holding frame 532 may slide along the at least two supports 513 via the worm 536, the worm gear 535, and the rack 534. In this way, the neutral density filter 531 may be inserted into or recedes from the optical path of the photographing apparatus 100. The worm 536, the worm gear 535, and the rack 534 are non-limiting examples of a fourth worm, a fourth worm gear, and a fourth rack, respectively.

In the optical filtering apparatus 500 constructed in the foregoing manner according to some exemplary embodiments of the present disclosure, each of the neutral density filter 501 and the neutral density filter 521 that are slidably supported on the support 503, as well as each of the neutral density filter 511 and the neutral density filter 531 that are slidably supported on the support 513, may be simultaneously inserted into the optical path of the photographing apparatus 100. In other words, each of the neutral density filter 501 and the neutral density filter 521 may be configured in the optical axis direction overlapping each of the neutral density filter 511 and the neutral density filter 531.

In addition, a width between the at least two supports 503 may be different from a width between the at least two supports 513. The width between the at least two supports 503 may be greater than the width between the at least two supports 513. As shown in FIG. 8, a spacing between the at least two supports 503 and the at least two support 513 in the optical axis direction may be smaller than a spacing when the at least two supports 503 and the at least two support 513 are configured in parallel along the optical axis direction. In this way, the thickness of the optical filtering apparatus 500 in the optical axis direction may be further reduced, and the flange focal length indicating the distance between the lens mount 800 and the camera surface of the image sensor 120 may be further reduced.

The width between the at least two supports 503 may be the same as the width between the at least two support 513, and the at least two supports 503 and the at least two support 513 may be staggered along the direction perpendicular to the optical axis. A distance from the optical axis to one of the at least two supports 503 that supports the first side member 5021 of the holding frame 502 may be different from a distance from the optical axis to one of the at least two supports 513 that supports the first side member 5121 of the holding frame 512. In addition, a distance from the optical axis to the other one of the at least two supports 503 that supports the second side member 5022 of the holding frame 502 may be different from a distance from the optical axis to the other one of the at least two supports 513 that supports the second side member 5122 of the holding frame 512. In this way, the at least two supports 503 and the at least two supports 513 may be staggered along the direction perpendicular to the optical axis, so that the distance between the at least two supports 503 and the at least two supports 513 in the optical axis direction may be reduced. In this way, the thickness of the optical filtering apparatus 500 in the optical axis direction may be further reduced, and the flange focal length may be further reduced.

The motor 508 may be arranged at a position that is closer to the neutral density filter 501 that is inserted into the optical path than the neutral density filter 501 that has receded from the optical path. The motor 518 may be arranged at a position that is closer to the neutral density filter 511 that is inserted into the optical path than the neutral density filter 511 that has receded from the optical path. The motor 528 may be arranged at a position that is closer to the neutral density filter 521 that is inserted into the optical path than the neutral density filter 521 that has receded from the optical path. The motor 538 may be arranged at a position that is closer to the neutral density filter 531 that is inserted into the optical path than the neutral density filter 531 that has receded from the optical path.

In other words, the motor 508 may be arranged near the center, instead of at one end of the support 503. Similarly, the motor 518 may be arranged near the center of the support 513. The motor 528 may be arranged near the center of the support 503. The motor 538 may be arranged near the center of the support 513.

The drive shaft of the motor 518 may be configured to be in a first direction 601 along the rack 514. The drive shaft of the motor 528 may be configured to be in a second direction 602 opposite to the first direction 601 along the rack 524 and is configured opposite to the drive shaft of the motor 518. The drive shaft of the motor 508 may be configured to be in the first direction 601 along the rack 504. The drive shaft of the motor 538 may be configured to be in the second direction 602 opposite to the first direction 601 along the rack 534 and may be configured to be opposite to the drive shaft of the motor 508. The motor 508, the motor 518, the motor 528, and the motor 538 may be configured symmetrically with the optical axis as a center.

To configure the motor 508, the motor 518, the motor 528, and the motor 538 as described above, the motor 508, the motor 518, the motor 528, and the motor 538 may be configured to be near the center of gravity of the optical filtering apparatus 500 and the photographing apparatus 100. In this way, when the photographing apparatus 100 may be supported by the support device, shaking of the center of gravity of the photographing apparatus 100 may still be suppressed even if the attitude of the photographing apparatus 100 may be changed. Because the shaking of the center of gravity of the photographing apparatus 100 may be suppressed, load of the support device supporting the photographing apparatus 100 may be reduced.

The structure of the support is not limited to the foregoing content. Any structure may be used, provided that the structure may slidably support the optical filter along the direction perpendicular to the optical axis. In some exemplary embodiments according to the present disclosure, the support 503 and the support 513 may include hollow rod components. In this case, rod shaft members may be disposed on respective side members of the holding frame 502, the holding frame 512, the holding frame 522, and the holding frame 532. The support 503 and the support 513 may accommodate the holding frame 502, the holding frame 512, the holding frame 522, and the holding frame 532 in the hollow part of the rod-shaped component, to slidably support the holding frame 502, the holding frame 512, the holding frame 522, and the holding frame 532.

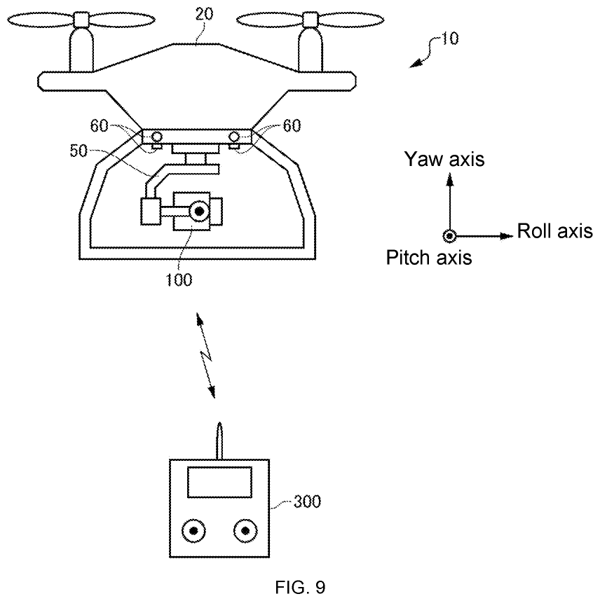

The photographing apparatus 100 may be mounted on a movable object. The photographing apparatus 100 may alternatively be mounted on a UAV shown in FIG. 9 according to some exemplary embodiments of the present disclosure. A UAV 10 may include a UAV main body 20, a gimbal 50, a plurality of photographing apparatuses 60, and a photographing apparatus 100. The gimbal 50 and the photographing apparatus 100 together may be a non-limiting example of a photographing system. The UAV 10 may be a non-limiting example of a movable object propelled by a propulsion member. The movable object refers to a concept of a flying object such as another aircraft moving in the air, a vehicle moving on the ground, a ship moving on the water, or the like, in addition to the UAV.

The UAV main body 20 may include a plurality of propellers. The plurality of propellers is a non-limiting example of the propulsion member. The UAV main body 20 controls the plurality of propellers to rotate to enable the UAV 10 to fly. The UAV main body 20 uses four propellers to enable the UAV 10 to fly. A quantity of the propellers is not limited to four. In addition, the UAV 10 may alternatively be a fixed-wing aircraft without any propellers.

The photographing apparatus 100 may be a camera for photographing a to-be-photographed object included in a desired camera range. A non-limiting example of a support device may be a gimbal 50. The gimbal 50 rotatably supports the photographing apparatus 100. In some exemplary embodiments according to the present disclosure, the gimbal 50 uses an actuator to rotatably support the photographing apparatus 100 with a pitch axis as a center. The gimbal 50 uses the actuator to further rotatably support the photographing apparatus 100 with a roll axis and a yaw axis as centers. The gimbal 50 can change an attitude of the photographing apparatus 100 by causing the photographing apparatus 100 to rotate with respect to at least one of the yaw axis, the pitch axis, or the roll axis as a center of rotation.

The plurality of photographing devices 60 are sensing cameras that photograph surroundings of the UAV 10 to aid the control the flight of the UAV 10. In some exemplary embodiments according to the present disclosure, two photographing devices 60 may be arranged on a nose of the UAV 10, that is, on the front side. In addition, the other two photographing devices 60 may be arranged on a bottom surface of the UAV 10. The two photographing devices 60 on the front side may be paired to function as stereo cameras. The two photographing devices 60 on the bottom surface may also be paired to function as stereo cameras. Perspective space data around the UAV 10 may be generated based on images captured by the plurality of photographing devices 60. A quantity of photographic devices 60 included by the UAV 10 is not limited to four. In some exemplary embodiments according to the present disclosure, the UAV 10 may include at least one photographing device 60. Alternatively, the UAV 10 may include at least one photographing device 60 on each of the nose, a tail, a side surface, a bottom surface, and a top surface of the UAV 10. A viewing angle that can be set in the photographing device 60 may be greater than a viewing angle that can be set in the photographing apparatus 100. The photographing device 60 may also have a single focus lens or a fisheye lens.

The remote operation device 300 may communicate with the UAV 10 to remotely operate the UAV 10. The remote operation device 300 may perform wireless communication with the UAV 10. The remote operation device 300 sends, to the UAV 10, indication information of various instructions related to movement of the UAV 10 such as ascending, descending, accelerating, decelerating, moving forward, moving backward, and rotating. The non-limiting exemplary indication information may include an indication information causing the UAV 10 to ascend. The indication information may indicate a height at which the UAV 10 needs to be located. The UAV 10 moves to be located at the height indicated by the indication information received from the remote operation device 300. The indication information may include an ascending instruction to raise the UAV 10. The UAV 10 ascends after receiving the ascending instruction. When the flight height of the UAV 10 has reached an upper limit height, ascending of the UAV 10 may be limited even if the ascending instruction is received.

The exemplary embodiments according to the present disclosure is described above by using the implementations. However, the technical scope of the exemplary embodiments according to the present disclosure is not limited to the scope described in the foregoing implementations. Apparently, a person of ordinary skill in the art can make various changes or improvements to the implementations. It is apparent from the description of the claims that all manners to which such changes or improvements are made can be included within the technical scope of the present disclosure.

It should be noted that the execution order of the actions, sequences, steps, and stages of the apparatuses, systems, programs, and methods in the claims, specification, and accompanying drawings of the specification can be implemented in any order, provided that there is no special statement such as “before . . . ” or “in advance”, and an output of previous processing is not used in subsequent processing. The operation procedures in the claims, specification, and accompanying drawings of the specification are described using “first” and “next” for convenience, but it does not mean that an implementation must be implemented in such an order.

What is claimed is:

1. An optical filtering apparatus, comprising:
a first optical filter;
a first holding frame, holding the first optical filter;
at least two first supports, slidably supporting a first side member and a second side member of the first holding frame, respectively;
a first motor;
a first transmission, transmitting power from the first motor to the first holding frame to drive the first holding frame to slide along the two first supports, causing the first optical filter to be inserted into or recede from an optical path of a photographic apparatus;
a second optical filter;
a second holding frame, holding the second optical filter;
at least two second supports, being arranged adjacent to the at least two first supports respectively, and slidably supporting a first side member and a second side member of the second holding frame respectively;
a second motor; and
a second transmission, transmitting power from the second motor to the second holding frame to drive the second holding frame to slide along the two second supports, causing the second optical filter to be inserted into or recede from the optical path, wherein:
a distance from an optical axis of the photographing apparatus to one of the at least two first supports that supports the first side member of the first holding frame is different from a distance from the optical axis to one of the at least two second supports that supports the first side member of the second holding frame, and
a distance from the optical axis to the other one of the at least two first supports that supports the second side member of the first holding frame is different from a distance from the optical axis to the other one of the at least two second supports that supports the second side member of the second holding frame.

2. The optical filtering apparatus according to claim 1, wherein a width between the at least two first supports is different from a width between the at least two second supports.

3. The optical filtering apparatus according to claim 1, wherein the first motor is closer to the first optical filter when the first optical filter is inserted into the optical path than when the first optical filter has receded from the optical path, and
the second motor is closer to the second optical filter when the second optical filter is inserted into the optical path than when the second optical filter has receded from the optical path.

4. The optical filtering apparatus according to claim 3, wherein the first motor and the second motor are located on opposite sides with respect to the optical axis.

5. The optical filtering apparatus according to claim 4, wherein
the first transmission includes: a first rack arranged on the first side member of the first holding frame, a first worm gear engaged with the first rack, and a first worm engaged with the first worm gear and connected to a drive shaft of the first motor; and
the second transmission includes: a second rack arranged on the second side member of the second holding frame, a second worm gear engaged with the second rack, and a second worm engaged with the second worm gear and connected to a drive shaft of the second motor.

6. The optical filtering apparatus according to claim 1, further comprising:
a third optical filter;
a third holding frame, having a first side member and a second side member slidably supported by the at least two first supports respectively, and holding the third optical filter;
a third motor; and
a third transmission, transmitting power from the third motor to the third holding frame to drive the third holding frame to slide along the at least two first supports, causing the third optical filter to be inserted into or recede from the optical path.

7. The optical filtering apparatus according to claim 6, wherein
the first transmission includes: a first rack arranged on the first side member of the first holding frame, a first worm gear engaged with the first rack, and a first worm engaged with the first worm gear and connected to a drive shaft of the first motor;
the second transmission includes: a second rack arranged on the second side member of the second holding frame, a second worm gear engaged with the second rack, and a second worm engaged with the second worm gear and connected to a drive shaft of the second motor; and
the third transmission includes: a third rack arranged on the second side member of the third holding frame, a third worm gear engaged with the third rack, and a third worm engaged with the third worm gear and connected to a drive shaft of the third motor.

8. The optical filtering apparatus according to claim 7, wherein the drive shaft of the second motor is configured in a first direction along the second rack; and
the drive shaft of the third motor is configured in a second direction opposite to the first direction along the third rack and is configured opposite to the drive shaft of the second motor.

9. The optical filtering apparatus according to claim 6, further comprising:
a fourth optical filter;
a fourth holding frame, having a first side member and a second side member slidably supported by the at least two second supports respectively, and holding the fourth optical filter;
a fourth motor; and
a fourth transmission, transmitting power from the fourth motor to the fourth holding frame, to drive the fourth holding frame to slide along the at least two second supports, the fourth optical filter inserts into or recedes from the optical path.

10. The optical filtering apparatus according to claim 9, wherein:
the first transmission includes: a first rack arranged on the first side member of the first holding frame, a first worm gear engaged with the first rack, and a first worm engaged with the first worm gear and connected to a drive shaft of the first motor;
the second transmission includes: a second rack arranged on the second side member of the second holding frame, a second worm gear engaged with the second rack, and a second worm engaged with the second worm gear and connected to a drive shaft of the second motor;
the third transmission includes: a third rack arranged on the second side member of the third holding frame; a third worm gear engaged with the third rack; and a third worm engaged with the third worm gear and connected to a drive shaft of the third motor; and
the fourth transmission includes: a fourth rack arranged on the first side member of the fourth holding frame, a fourth worm gear engaged with the fourth rack, and a fourth worm engaged with the fourth worm gear and connected to a drive shaft of the fourth motor.

11. The optical filtering apparatus according to claim 10, wherein the drive shaft of the second motor is configured in a first direction along the second rack;
the drive shaft of the third motor is configured in a second direction opposite to the first direction along the third rack and is configured opposite to the drive shaft of the second motor;
the drive shaft of the first motor is configured in the second direction; and
the drive shaft of the fourth motor is configured in the first direction and is configured opposite to the drive shaft of the first motor.

12. The optical filtering apparatus according to claim 9, wherein at least one of the first optical filter, the second optical filter, the third optical filter, or the fourth optical filter is a neutral density filter.

13. A photographing system, comprising:
a photographing apparatus including an image sensor receiving light passing through an optical filtering apparatus;
the optical filtering apparatus including:
a first optical filter;
a first holding frame, holding the first optical filter;
at least two first supports, slidably supporting a first side member and a second side member of the first holding frame, respectively;
a first motor;
a first transmission, transmitting power from the first motor to the first holding frame to drive the first holding frame to slide along the two first supports, causing the first optical filter to be inserted into or recede from an optical path of a photographic apparatus;
a second optical filter;
a second holding frame, holding the second optical filter;
at least two second supports, being arranged adjacent to the at least two first supports respectively, and slidably supporting a first side member and a second side member of the second holding frame respectively;
a second motor; and
a second transmission, transmitting power from the second motor to the second holding frame to drive the second holding frame to slide along the two second supports, causing the second optical filter to be inserted into or recede from the optical path, wherein:
a distance from an optical axis of the photographing apparatus to one of the at least two first supports that supports the first side member of the first holding frame is different from a distance from the optical axis to one of the at least two second supports that supports the first side member of the second holding frame, and
a distance from the optical axis to the other one of the at least two first supports that supports the second side member of the first holding frame is different from a distance from the optical axis to the other one of the at least two second supports that supports the second side member of the second holding frame.

14. The photographing system according to claim 13, further comprising:
a support device to support the photographing apparatus and to adjust an attitude of the photographing apparatus.

15. The photographing system according to claim 14, further comprising
a movable object, wherein the photographing apparatus is mounted on the movable object.

16. The photographing system according to claim 13, wherein a width between the at least two first supports is different from a width between the at least two second supports.

17. The photographing system according to claim 13, wherein the first motor is closer to the first optical filter when the first optical filter is inserted into the optical path than when the first optical filter has receded from the optical path, and
the second motor is closer to the second optical filter when the second optical filter is inserted into the optical path than when the second optical filter has receded from the optical path.

18. The photographing system according to claim 13, further comprising:
a third optical filter;
a third holding frame, having a first side member and a second side member slidably supported by the at least two first supports respectively, and holding the third optical filter;
a third motor; and
a third transmission, transmitting power from the third motor to the third holding frame to drive the third holding frame to slide along the at least two first supports, causing the third optical filter to be inserted into or recede from the optical path.

19. The photographing system according to claim 18, further comprising:
a fourth optical filter;
a fourth holding frame, having a first side member and a second side member slidably supported by the at least two second supports respectively, and holding the fourth optical filter;
a fourth motor; and
a fourth transmission, transmitting power from the fourth motor to the fourth holding frame, to drive the fourth holding frame to slide along the at least two second supports, the fourth optical filter inserts into or recedes from the optical path.

20. The photographing system according to claim 19, wherein:
the first transmission includes: a first rack arranged on the first side member of the first holding frame, a first worm gear engaged with the first rack, and a first worm engaged with the first worm gear and connected to a drive shaft of the first motor;
the second transmission includes: a second rack arranged on the second side member of the second holding frame, a second worm gear engaged with the second rack, and a second worm engaged with the second worm gear and connected to a drive shaft of the second motor;
the third transmission includes: a third rack arranged on the second side member of the third holding frame; a third worm gear engaged with the third rack; and a third worm engaged with the third worm gear and connected to a drive shaft of the third motor; and
the fourth transmission includes: a fourth rack arranged on the first side member of the fourth holding frame, a fourth worm gear engaged with the fourth rack, and a fourth worm engaged with the fourth worm gear and connected to a drive shaft of the fourth motor.
